(19) United States
(12) Patent Application Publication
(10) Pub. No.: US 2007/0094272 A1
(43) Pub. Date: Apr. 26, 2007

(54) Method and system for managing distributed storage of digital contents

(76) Inventor: Wen-Hsi Yeh, Taipei City (TW)

Correspondence Address: J.C. Patents, Inc., Suite 250, 4 Venture, Irvine, CA, 92618, US

(21) Appl. No.: 11/400,078

(22) Filed: Apr. 6, 2006

(30) Foreign Application Priority Data
Oct. 20, 2005 (TW) 94136675

(51) Int. Cl. G06F 17/30

(52) U.S. Cl. 707/10

(57) ABSTRACT

A method and a system for managing distributed storage of digital contents are provided. The method comprises the following steps. First, generate multiple pieces of shared data based on the shared information through a secure dispatching algorithm, wherein the shared information includes a digital content and a license of the digital content. Then, store the shared data in a digital content server and register metadata of the shared data into a directory server. Furthermore, inquire the list of the hosts having the shared data at the directory server. Acquire a part of the shared data according to the host list. And then assemble the part of shared data into the shared information through a secure retrieving algorithm. Control the use of the digital content according to the license. Finally, update metadata of shared data of stored digital contents at the directory server.

### CROSS-REFERENCE TO RELATED APPLICATION

This application claims the priority benefit of Taiwan application serial no. 94136675, filed on Oct. 20, 2005. All disclosure of the Taiwan application is incorporated herein by reference.

### BACKGROUND OF THE INVENTION

1. Field of Invention

The present invention relates to a method and a system for managing distributed storage of digital contents. More particularly, the present invention relates to a method and a system for managing distributed storage of digital contents by combining the secret sharing algorithm and the digital rights management (DRM) mechanism.

2. Description of Related Art

In recent technology, for the digital contents provided by the digital content management platform, in most cases, a single content is stored in a file system or database, or alternatively, the digital contents are placed in a server of a network server service provider. In the former scheme, online digital content platform provider must maintain one or more powerful servers as well as a network environment with enough bandwidth, while in the latter scheme, the flow of the digital data may not be easily controlled.

Compared with a bulky single system, a distributed system can distribute the network traffic and reduce the load of the server. Distributed storage is mostly applied to intranet data storage, and the recently popular peer to peer (P2P) can be considered as another application thereof. The data is distributed and stored in different positions through a specific mechanism, and the data may be retrieved through a searching mechanism to find the distributed parts of the data, then the parts are assembled into the original data after they are acquired through network transmission. This distributed storage technology has several different requirements, including content sharing, content security, metadata synchronization, download acceleration, distributed system fault tolerance, etc.

U.S. Pat. No. 5,625,692, No. 5,991,414, and No. 6,192,472 by IBM disclose a distributed storage system, in which the digital content authors upload encrypted digital contents and encryption keys through respective servers. While the secret sharing algorithm is used to encrypt the data, the three patents still have some disadvantages to be overcome. First, the provider still has to maintain powerful servers as well as a network environment with enough bandwidth, due to the lack of a large-scale distributed architecture such as P2P. Moreover, since the secret sharing algorithm used in such a technique protects the whole digital content. The larger the digital content file, the poorer the efficiency of distribution and assembly of the digital contents, larger digital data may suffer from low efficiency.

As for P2P software such as eDonkey, although content sharing, distributed network traffic, and download acceleration can be achieved by high degree of distribution, data security is not in place, and distribution control mechanisms such as DRM are also lacking.

It can be seen from the above description that a system with better balanced network traffic, higher efficiency of distribution and assembly of secret sharing, and complete and effective data security and distribution control is still desired.

### SUMMARY OF THE INVENTION

Accordingly, the present invention is directed to provide a method for managing distributed storage of digital contents. The present method applies a secret sharing algorithm in the distributed secure storage mechanism, and can not only provide distributed storage, multi-source service, and distributed network traffic, but also avoid the low efficiency when sharing larger data.

The present invention is further directed to provide a system for managing distributed storage of digital contents, which provides a secure and efficient digital content distributed storage mechanism by combining the client-server architecture and the P2P conception. Further, the present system incorporates a DRM mechanism at the user terminal, for providing copyrights protection and communication management, to ensure that the digital contents will not be leaked when in use.

In order to reach the above and other objects, the present invention provides a method for managing distributed storage of digital contents, comprising the following steps. (a) Generate multiple pieces of shared data based on shared information through a secure dispatching algorithm, wherein the shared information includes a digital content and a license of the digital content. Then, (b) store the shared data in the digital content server, and (c) register metadata of the shared data into a directory server. Furthermore, (d) inquire for the list of the hosts having the shared data at the directory server, and (e) acquire a part of the shared data according to the host list, then (f) assemble the part of the shared data into the shared information through a secure retrieving algorithm. Then, (g) control the use of the digital content according to the license. Finally, (h) update metadata of shared data of stored digital contents at the directory server.

In an embodiment of the above method for managing distributed storage of digital contents, the step (e) further includes the following steps. First, try to acquire the part of the shared data from the users' host on the host list. If the acquired shared data is not enough for assembly, acquire the missing shared data from the digital content server.

In an embodiment of the above method for managing distributed storage of digital contents, the step (g) further includes the following steps. Retain only a part of the above shared data, and if there's . not enough storage space for the shared data, delete a part of the shared data according to a predetermined condition.

In an embodiment of the above method for managing distributed storage of digital contents, the method further comprises performing the following steps at specific time periods. First, the directory server updates the directory server list with other known directory servers, then updates the directory server list with other newly added directory servers, and finally updates metadata of the shared data with all the other known directory servers.

In an embodiment of the above method for managing distributed storage of digital contents, the method further comprises the following steps. Delete shared data of some digital contents from the digital content server, delete the metadata of the shared data from the directory server, and delete expired shared data from the user's host.

From another perspective, the present invention further provides a system for managing distributed storage of digital contents, which comprises a digital content server, a directory server, and user's host software. The digital content server is used for storing multiple pieces of shared data generated based on shared information through a secure dispatching algorithm, and the shared information includes a digital content and a license of the digital content. The directory server is used for registering metadata of the shared data. The user's host software is used for inquiring the list of the hosts having the shared data at the directory server, acquiring a part of the shared data according to the host list, and assembling the part of shared data into the shared information through a secure retrieving algorithm. And then the user's host software is further used for controlling the use of the digital content according to the license, and for updating metadata of shared data of stored digital contents owned by the user's host at the directory server.

According to a preferred embodiment of the present invention, since the present invention combines the client-server architecture and the P2P concept, distributed storage, multi-source service, and distributed network traffic can be provided. The present invention employs a secret sharing algorithm to encrypt digital contents. However, the present invention is different from the previous IBM patents that protect the whole digital content with the secret sharing algorithm in that the secret sharing algorithm is only used to protect the encryption key. Since the encryption key is much smaller than the digital content file, the present invention can avoid low efficiency when the size of the shared content is increased.

Moreover, in the system for managing distributed storage of digital contents of the present invention, the original digital content server is the only host which keeps all the shared data, all the users' hosts simply store a part of the shared data. A single user's host or a few users' hosts cannot acquire partial or complete information of the digital content with their shared data through computations. On the other hand, when a user want to acquire the digital content, there is nothing for it but to pass the authentication mechanism of the directory server, and the user must obey the grant setting of the rights when using or storing the digital content. Therefore, the present invention provides rights protection and communication management to ensure that the digital content will not leak while in use.

In order to the make the aforementioned and other objects, features, and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 are schematic views of a system for managing distributed storage of digital contents according to an embodiment of the present invention.

FIG. 3 to FIG. 7 are sequence diagrams of a method for managing distributed storage of digital contents according to an embodiment of the present invention.

FIG. 8 is a sequence diagram of a secure dispatching algorithm according to an embodiment of the present invention.

FIG. 9 is a sequence diagram of a secure retrieving algorithm according to an embodiment of the present invention.

### DESCRIPTION OF EMBODIMENTS

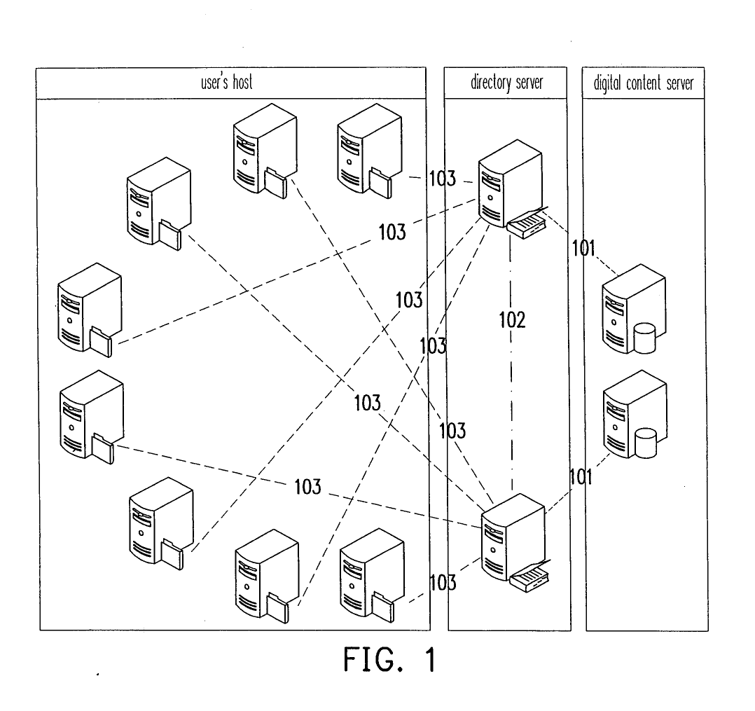

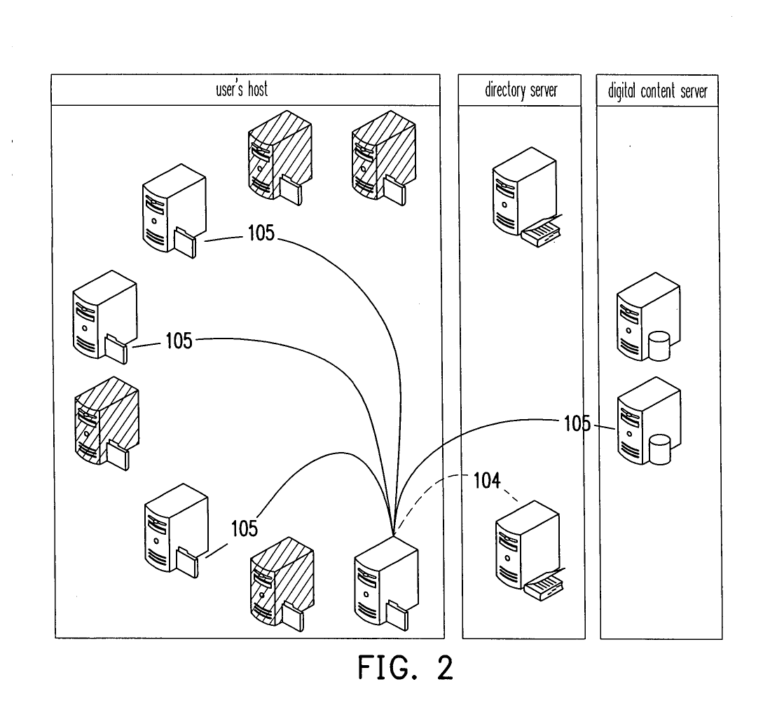

The following description refers to FIG. 1 and FIG. 2. FIG. 1 and FIG. 2 are schematic views of a system for managing distributed storage of digital contents according to an embodiment of the present invention. The system in FIG. 1 and FIG. 2 performs the method for managing distributed storage of digital contents according to this embodiment of the present invention. The computers in the system include digital content servers, directory servers, and users' hosts. A specific software is installed on the user's host for performing the method for managing distributed storage of digital contents according to this embodiment. The user's host software can be a standalone application or a plug-in component.

The method for managing distributed storage of digital contents in this embodiment will be described briefly herein below. The process starts from step 101 of FIG. 1. In step 101, a digital content provider assembles a digital content and a license of the digital content into the shared information; then n pieces of shared data are generated based on the shared information through a secure dispatching algorithm; the n pieces of shared data are saved in a digital content server, and then metadata of the n pieces of shared data are registered at the directory server. This embodiment employs a (n,t) secret sharing algorithm; that is, the shared information is divided into n pieces of shared data and stored respectively, and thereafter, at least t pieces of the shared data must be acquired to retrieve the shared information, and to thereby acquire the digital content and the license of the digital content in the shared information. As for the metadata registered at the directory server, it is used mainly for tracking storage location of shared data of all online digital contents.

Then, in step 102, the directory server performs synchronization at specific time periods, for updating metadata of shared data that have been added, modified, or deleted since the previous synchronization. Then, in step 103, after the user's host software logs onto the directory server, metadata of shared data of each digital content owned by the user's host are uploaded to the directory server, and then the directory server synchronizes metadata of shared data of digital contents which are presently available online with other directory servers at specific time periods.

Furthermore, in step 104 of FIG. 2, a user connects to any directory server through the user's host software, for querying metadata of shared data of a certain digital content, and the directory server may send the host list having the shared data of the digital content back to the user's host software.

Finally, in step 105, after the user's host software acquires the above host list, it connects directly to each user's host and digital content server having the shared data of the digital content, for acquiring each piece of shared data (at least t pieces) respectively. In the very beginning, a new digital content should be totally downloaded from the digital content server. Then, the user's host may start to provide the self-owned shared data of digital contents, for distributing network traffic via P2P mechanism, thus reducing the load of the digital content server.

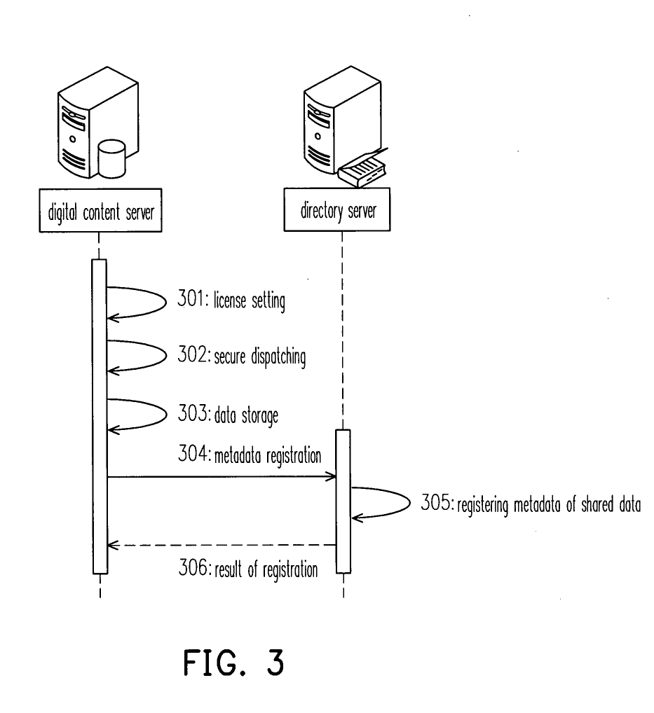

The detailed process of the method for managing distributed storage of digital contents of this embodiment will be described with reference to FIGS. 3 to 7. First, FIG. 3 is a sequence diagram of storing and registering shared data of digital contents by the digital content provider in the present method.

At first, in step 301, the digital content provider creates a license of a digital content. Then, in step 302, the digital content and the license file are assembled into the shared information, which is then divided into n pieces of shared data through a secure dispatching algorithm. Thereafter, in step 303, the n pieces of shared data are stored in the digital content server, and in step 304, metadata of the n pieces of shared data are registered at the directory server. Furthermore, the directory server registers the metadata of the shared data at a database in step 305, and in step 306, a result of registration is sent back to the digital content server.

In the future, if the digital content platform provider wants to modify the license of the digital content, what is set in the rights authorization of the digital content may be modified. The process of step 301 to step 306 is repeated, to divide the digital content and the license, and to link to the directory server for reregistering the shared data.

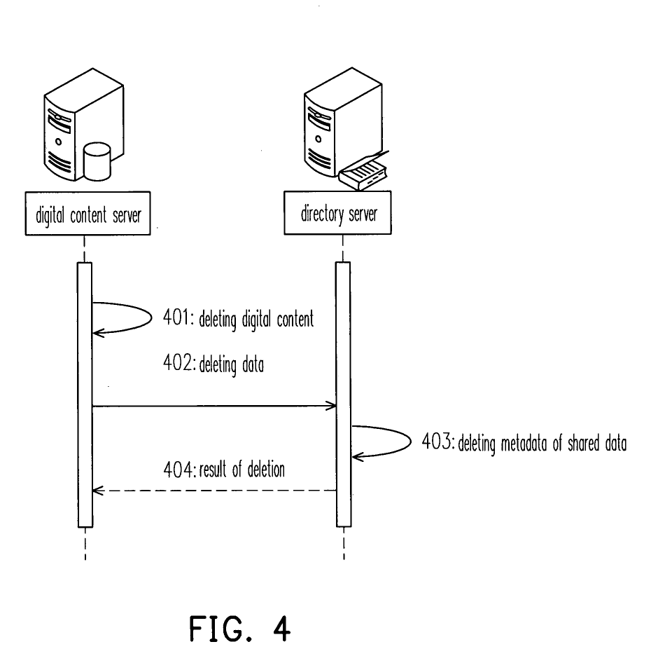

FIG. 4 is a detailed sequence diagram of deleting a digital content in the method for managing distributed storage of digital contents of this embodiment. When the digital content provider wants to delete a shared digital content from the system for business or rights issues, first, it sets the digital content is to be deleted, and then the digital content server deletes all stored shared data of the digital content in step 401, and notifies the directory server of metadata of the deleted shared data of the digital content in step 402. After that, the directory server deletes the registered metadata of the shared data of the digital content in step 403, and sends back a deletion result to the digital content server in step 404.

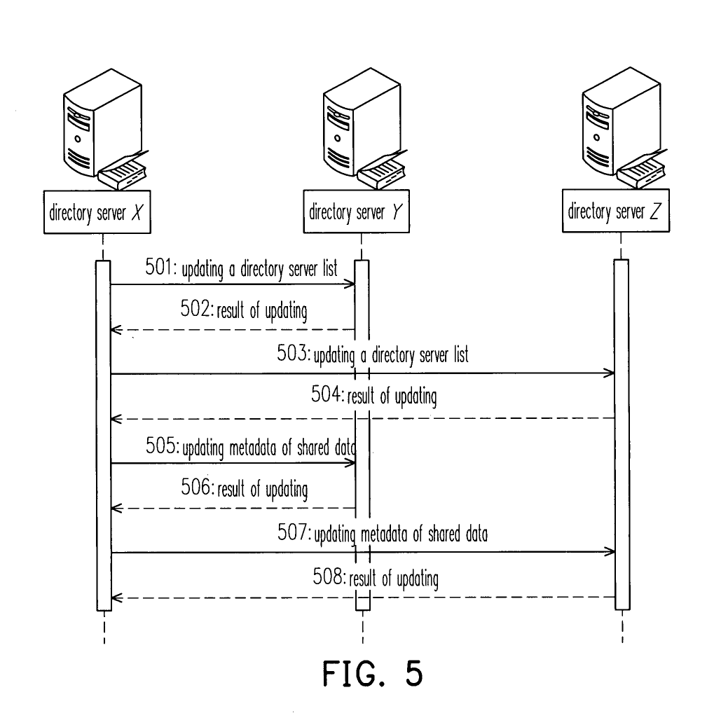

FIG. 5 is a detailed sequence diagram of synchronizing metadata of shared data between directory servers in the method for managing distributed storage of digital contents in this embodiment. As described above, metadata of shared data will be synchronized among directory servers at specific time periods. It is assumed that the synchronization starts form the directory server X of FIG. 5.

First, in steps 501 and 502, the directory server X updates a directory server list with a known directory server Y, and learns the existence of a directory server Z from the updated directory server list. Then, in steps 503 and 504, the directory server X updates the directory server list with the newly added directory server Z. Then, in steps 505 to 508, the directory server X updates metadata of newly added, modified, or deleted shared data with the directory servers Y, Z in the known list.

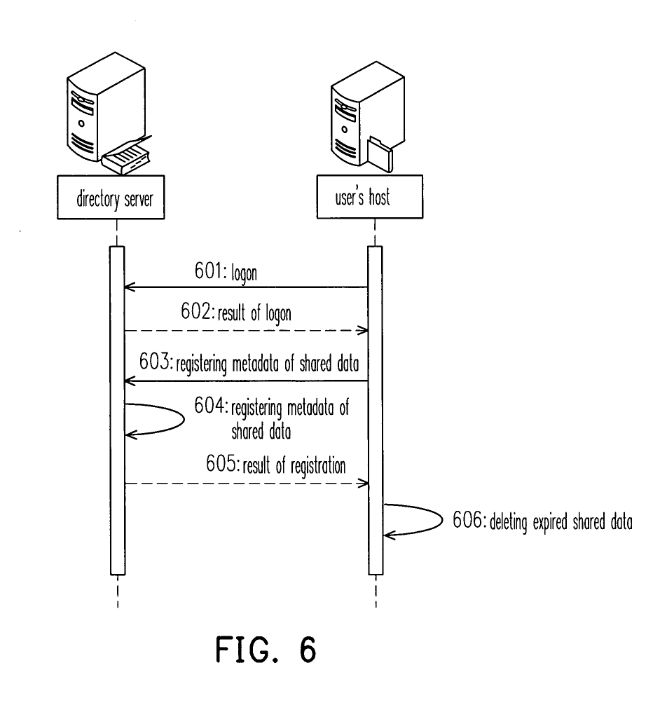

Furthermore, FIG. 6 is a detailed sequence diagram of registering metadata of shared data by a user's host in the method for managing distributed storage of digital contents in this embodiment. This process can be performed at specific time periods, for updating metadata of shared data in the directory server, and shared data of digital contents stored in the user's host.

First, the user's host software logs onto the directory server successfully in steps 601 and 602, then registers metadata of shared data of digital contents currently owned by the user's host at the directory server in step 603, while notifying the directory server of the current upload bandwidth of the user's host. Then, the directory server registers the metadata of the shared data at the database in step 604, to check whether there is shared data of any updated or deleted digital content, and sends back a registration result in step 605. And the current upload bandwidth of the user's host is recorded simultaneously, as the priority sequence of the user's host assignment in the new shared data host list. Finally, the user's host software receives the registration result sent back by the directory server in step 606, and then checks whether it is necessary to delete expired shared data (i.e. the digital content has been set by the modified license of the original digital content server, or the distributed storage for the digital content has been deleted).

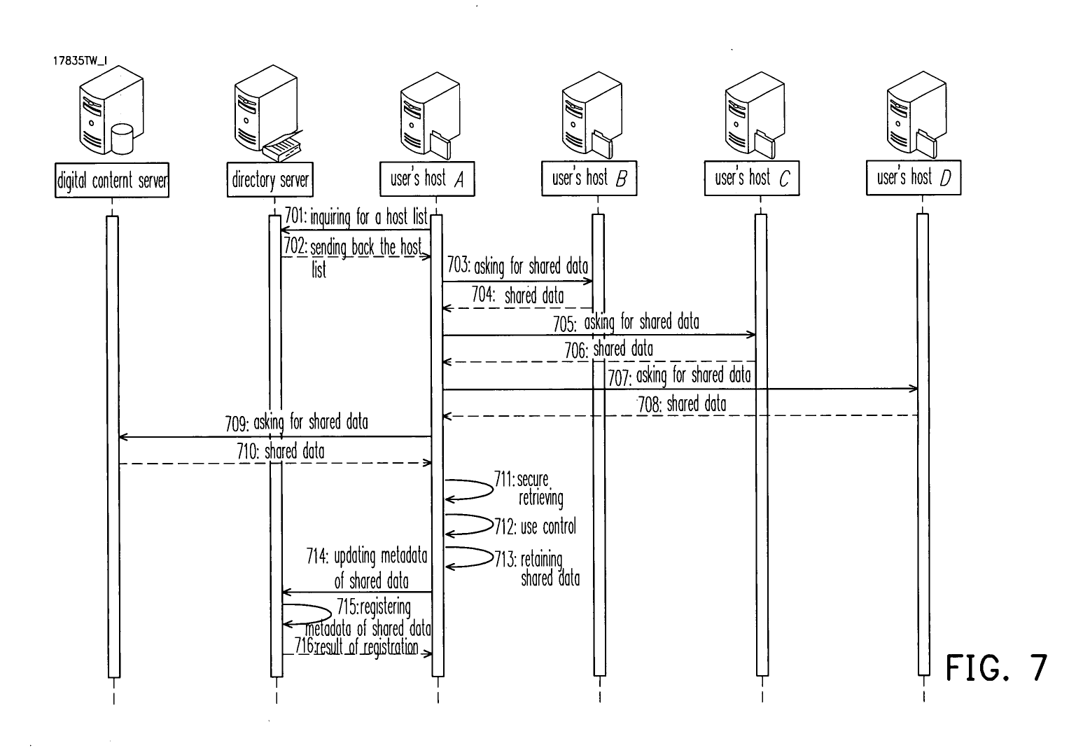

FIG. 7 is a detailed sequence diagram of acquiring shared data of digital contents by the user's host in the method for managing distributed storage of digital contents in the present embodiment. It is assumed that a user A's host software in FIG. 7 (user's host A, B, C or D hereinafter) is to acquire the shared data.

First, the user's host A inquires for the list of hosts having the required shared data of a digital content with the known directory server in step 701. The directory server sends back the list of the hosts currently having the shared data of the digital content to the user's host A in step 702. After acquiring the host list, the user's host A first tries to acquire at least t pieces of the shared data from other users' hosts on the host list for reducing the load of the digital content server. If the shared data acquired from other users' hosts on the host list is not sufficient to assemble into the original shared information, i.e. less than t pieces, the user's host A acquires the missing shared data from the digital content server. It is assumed that the above host list includes users' hosts B, C, and D, and then, the user's host A asks the users' hosts B, C, and D for a part of the shared data in steps 703, 705, and 707 respectively, and the users' hosts B, C, and D respond to the request of the user's host A respectively in steps 704, 706, and 708, sending back the owned shared data of the digital content, and updating their respective credits. The credit in this embodiment is used as a reward for the user's host participating in the P2P.

In the example of FIG. 7, the shared data acquired by the user's host A from the users' hosts B, C, and D is fewer than t pieces. Therefore, in step 709, the user's host A requires the digital content server for the missing shared data of the digital content in the manner of credit deduction and/or trade payment. The digital content server sends back the shared data requested by the user's host A in step 710.

After acquiring enough shared data, the user's host A assembles the t pieces of shared data into an original digital content and the license file thereof through a secure retrieving algorithm in step 711, and then controls the use of the digital content according to the license through a rights management mechanism such as DRM and the like in step 712, i.e. limits the user's access right of the digital content. Furthermore, if the license does not allow the user's host to save a complete digital content, the user's host A only retains a part of the newly acquired shared data in step 713 and delete others. The retained part of the shared data is selective (for example, it is selected according to a license), or random. In the case of retaining a part of the shared data, if the same digital content is to be used next time, the process of FIG. 7 should also be repeated. Thus, the users' hosts can only hold a part of the shared data of any given digital content except the originally digital content server, and that is one of the mechanisms for protecting shared data in the present invention.

Moreover, in the case of limited storage space, the user's host software should check the storage space for shared information, and delete a part of the shared data according to a predetermined condition when the storage space is not sufficient. The predetermined condition may be deleting the oldest shared data or the shared data most seldom used, or may be any other condition that can be implemented by those of ordinary skill in the art.

Furthermore, the user's host A updates metadata of self-owned shared data of digital contents at the known directory server in step 714, and then, other users' hosts can ask the user's host A for shared data. Finally, the directory server registers the metadata of the shared data at the database in step 715, and sends back a registration result to the user's host A in step 716.

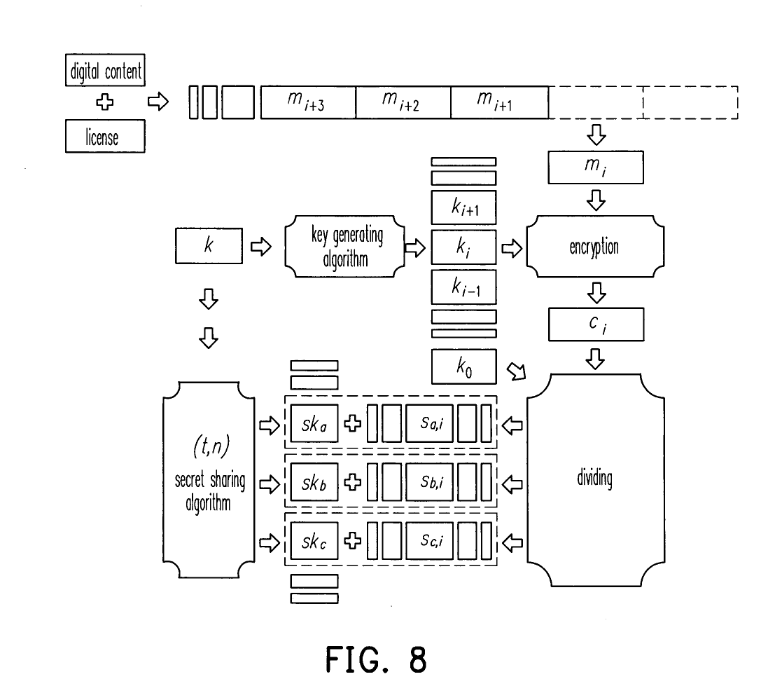

FIG. 8 is a sequence diagram of a secure dispatching algorithm for dividing shared information into n pieces of shared data in this embodiment, which comprises the following steps. A encryption key k is first generated at random, and the k is divided into n pieces sk₁, sk₂, . . . , skₐ, sk_{b}, sk_{c}, . . . , skₙ through a (t,n) secret sharing algorithm, wherein t and n can be adjusted according to the information size of the digital content. Then, the shared information M is first divided into data blocks m₁, m₂, . . . , mᵢ, with a fixed length, then a series of session keys k₀, k₁, k₂, . . . , kᵢ are generated based on k through a session key generation algorithm, and the k₁, k₂, . . . , kᵢ are used as encryption keys for performing a symmetric encryption operation on m₁, m₂, . . . , mᵢ respectively to generate ciphertext c₁, c₂, . . . , c₁. Furthermore, each of the ciphertext c₁, c₂, . . . , cᵢ is divided into n pieces by using the session key k₀, i.e. [s_{1,1}, s_{2,1}, . . . , s_{a,1}, s_{b,1}, s_{c,1}, . . . , s_{n,1}], [s_{1,2}, s_{2,2}, . . . , s_{a,2}, s_{b,2}, . . . , s_{c,2}, . . . , s_{n,2}], . . . , [s_{1,i}, s_{2,i}, . . . , s_{a,i}, s_{b,i}, s_{c,i}, . . . , s_{n,i}], which are then combined with the keys sk₁, sk₂, . . . , skₐ, sk_{b}, sk_{c}, . . . , skₙ to be rearranged into n pieces of shared data s₁=[sk₁, s_{1,1}, s_{1,2}, . . . , s_{1,i}], s₂=[sk₂, s_{2,1}, s_{2,2}, . . . , s_{2,i}], . . . , sₐ=[skₐ, s_{a,1}, s_{a,2}, . . . , s_{a,i}], s_{b}=[sk_{b}, s_{b}, s_{b,2}, . . . , s_{b,i}], s_{c}=[sk_{c}, s_{c,1}, s_{c,2}, . . . , s_{c,i}], . . . , sₙ=[skₙ, s_{n,1}, s_{n,2}, . . . , s_{n,i}] according to the group numbers.

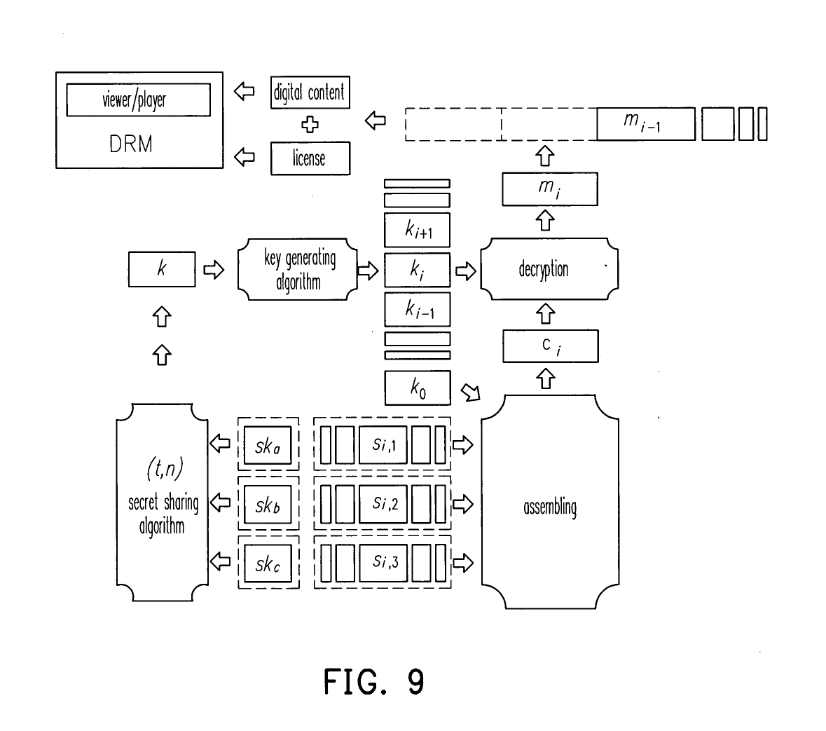

Finally, FIG. 9 is a sequence diagram of a secure retrieving algorithm by which the parts of the shared data are assembled into the shared information in this embodiment, which comprises the following steps. First, at least t pieces of shared data s₁, s₂, . . . , sₜ are acquired. Then, shared data of keys sk₁, sk₂, . . . , skₜ in respective pieces of the shared data are retrieved, and they are assembled into the original encryption key k through a secret sharing algorithm. After that, a series of session keys k₀, k₁, k₂, . . . , kᵢ are generated based on k through the session key generation algorithm. Moreover, the respective key is removed from each of the shared data, then the above pieces of the shared data are rearranged into n pieces of shared data of each ciphertext [s_{1,1}, s_{2,1}, . . . , s_{a,1}, s_{b,1}, s_{c,1}, . . . , s_{n,1}], [s_{1,2}, s_{2,2}, . . . , s_{a,2}, s_{b,2}, s_{c,2}, . . . , s_{n,2}], . . . , [s_{1,i}, s_{2,i}, . . . , s_{a,i}, s_{b,i}, s_{c,i}, . . , s_{n,i}] in orders. Furthermore, the n pieces of the shared data of each ciphertext are assembled into ciphertexts c₁, c₂, . . . , cᵢ through the session key k₀. And data blocks m₁, m₂, . . . , mᵢ are generated by performing a symmetric encryption operation on c₁, c₂, . . . , cᵢ respectively by using k₁, k₂, . . . , kᵢ as decryption keys. Then the original shared information M is obtained by connecting m₁, m₂, . . . , mᵢ in series, and finally the M is divided into a digital content and a license file.

In summary, since the present invention combines client-server architecture and the P2P concept, distributed storage, multi-source service, and distributed network traffic can be provided. The present invention employs a secret sharing algorithm to encrypt digital contents. However, the present invention is different from the previous IBM patents that protect the whole digital content with the secret sharing algorithm in that the secret sharing algorithm is only used to protect the encryption key. Since the encryption key is much smaller than the digital content file, the present invention can avoid low efficiency when the size of the shared content is increased.

Moreover, in the system for managing distributed storage of digital contents of the present invention, the original digital content server is the only host which keeps all the shared data, all the users' hosts simply store a part of the shared data. A single user's host or a few users' hosts cannot acquire partial or complete information of the digital content with their shared data through computations. On the other hand, when a user want to acquire the digital content, there is nothing for it but to pass the authentication mechanism of the directory server, and the user must obey the grant setting of the rights when using or storaging the digital content. Therefore, the present invention provides rights protection and communication management to ensure that the digital content will not leak while in use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for managing distributed storage of digital contents, comprising:
(a) generating multiple pieces of shared data based on a shared information through a secure dispatching algorithm, wherein the shared information includes a digital content and a license of the digital content;
(b) storing the shared data in a digital content server;
(c) registering metadata of the shared data into a directory server;
(d) inquiring a list of hosts having the shared data at the directory server;
(e) acquiring a part of the shared data according to the host list;
(f) assembling the part of shared data into the shared information through a secure retrieving algorithm;
(g) controlling the use of the digital content according to the license; and
(h) updating metadata of the shared data of stored digital content at the directory server.

2. The method for managing distributed storage of digital contents as claimed in claim 1, wherein the step (a) further includes:
setting the license of the digital content; and
assembling the digital content and the license into the shared information.

3. The method for managing distributed storage of digital contents as claimed in claim 1, wherein the step (e) further includes:
trying to acquire the part of shared data from the users' hosts on the host list; and
acquiring the missing shared data from the digital content server if the acquired shared data is not sufficient for assembly.

4. The method for managing distributed storage of digital contents as claimed in claim 3, further comprising:
acquiring the missing shared data from the digital content server in the manner of trade payment.

5. The method for managing distributed storage of digital contents as claimed in claim 3, further comprising:
updating the credit of each of the users' hosts after the user's host sends back the shared data; and
acquiring the missing shared data from the digital content server in the manner of credit deduction.

6. The method for managing distributed storage of digital contents as claimed in claim 1, wherein the step (g) further includes:
retaining a part of the shared data.

7. The method for managing distributed storage of digital contents as claimed in claim 1, wherein the step (g) further includes:
deleting a part of the shared data according to a predetermined condition if the storage space for the shared data is insufficient.

8. The method for managing distributed storage of digital contents as claimed in claim 1, further comprising performing the following steps at specific time periods:
updating a directory server list by the directory server with other known directory servers;
updating the directory server list by the directory server with other newly added directory servers; and
updating metadata of shared data by the directory server with all the known directory servers.

9. The method for managing distributed storage of digital contents as claimed in claim 1, further comprising:
setting deletion of the digital content;
deleting all the stored shared data of the digital content by the digital content server;
notifying the directory server of the metadata of the deleted shared data by the digital content server; and
deleting all the registered metadata of the shared data by the directory server.

10. The method for managing distributed storage of digital contents as claimed in claim 1, further comprising:
registering metadata of shared data of digital contents currently owned by a user's host at the directory server while notifying the directory server of the current upload bandwidth of the user's host by a user's host software;
checking whether there is updated or deleted shared data and sending back a registration result, while recording the upload bandwidth as the sequencing reference of the host list by the directory server; and
checking whether it is necessary to delete expired shared data according to the registration result by the user's host software.

11. A system for managing distributed storage of digital contents, comprising:
a digital content server for storing multiple pieces of shared data, wherein the shared data are generated based on a shared information through a secure dispatching algorithm, and the shared information comprises a digital content and a license of the digital content;
a directory server for registering metadata of the shared data; and
a user's host software for inquiring a list of hosts having the shared data at the directory server, acquiring a part of the shared data according to the host list, assembling the part of shared data into the shared information through a secure retrieving algorithm, then controlling the use of the digital content according to the license, and updating metadata of shared data of digital contents owned by the user's host at the directory server.

12. The system for managing distributed storage of digital contents as claimed in claim 11, wherein if the shared data acquired from the users' hosts on the host list by the user's host software is not sufficient for assembly, the user's host software acquires the missing shared data from the digital content server.

13. The system for managing distributed storage of digital contents as claimed in claim 12, wherein the user's host software acquires the missing shared data from the digital content server in the manner of trade payment.

14. The system for managing distributed storage of digital contents as claimed in claim 12, wherein each of the users' hosts on the host list updates the credit of the user's host after sending back the shared data, and the user's host software acquires the missing shared data from the digital content server in the manner of credit deduction.

15. The system for managing distributed storage of digital contents as claimed in claim 11, wherein the function of the user's host software further includes retaining a part of the shared data.

16. The system for managing distributed storage of digital contents as claimed in claim 11, wherein the function of the user's host software further includes deleting a part of the shared data according to a predetermined condition if the storage space for the shared data is insufficient.

17. The system for managing distributed storage of digital contents as claimed in claim 11, wherein the directory server updates a directory server list with other known directory servers at specific time periods, and updates the directory server list with other newly added directory servers at specific time periods, and then updates metadata of shared data with all the other known directory servers at specific time periods.

18. The system for managing distributed storage of digital contents as claimed in claim 11, wherein the function of the digital content server further includes deleting all the stored shared data of the digital content, and notifying the directory server of the metadata of the deleted shared data, and the function of the directory server further includes deleting all the registered metadata of the shared data.

19. The system for managing distributed storage of digital contents as claimed in claim 11, wherein the function of the user's host software further includes registering metadata of shared data of digital contents currently owned by the user's host at the directory server, while notifying the directory server of the current upload bandwidth of the user's host as the priority sequence of the host list, and checking whether it is necessary to delete expired shared data according to a registration result sent back by the directory server.
